(19) United States
(12) Patent Application Publication
(10) Pub. No.: US 2010/0162369 A1
(43) Pub. Date: Jun. 24, 2010

(54) Automatically Adding User Names to Server User List

(75) Inventor: Troy Taylor Davidson, Clinton, UT (US)

Correspondence Address: PROCOPIO, CORY, HARGREAVES & SAVITCH LLP, 525 B STREET, SUITE 2200, SAN DIEGO, CA, 92101, US

(73) Assignee: IOMEGA CORPORATION, San Diego, CA (US)

(21) Appl. No.: 12/339,557

(22) Filed: Dec. 19, 2008

(51) Int. Cl. H04L 9/32; G06F 15/16

(52) U.S. Cl. 726/5; 709/203

(57) ABSTRACT

A system and method in which when a user logs into a client computer with his user name, the client computer determines the existence of a server and the server automatically adds the user name to the list of users maintained by the server, is disclosed. With the user name automatically populated in the server user list, the administrator may easily select and configure access for the user.

### FIELD OF THE INVENTION

This invention relates to computer storage sever solutions, and more particularly to automatically adding a user name to a server user list.

### BACKGROUND

A standard server-client system includes one or more servers in a networked infrastructure. The network is in communication with one or more client computers which users access. In order for the one or more servers to handle security and limit access to resources, a user must be logged on to one of the client computers.

Accordingly, the server maintains a list of valid users and their access rights in a list or database. The list of users is created by a network administrator and the names are added to the list manually. This manual entry by the administrator is time consuming and requires an understanding of network server concepts. Thus, there is a need for a system and method that adds user names to the server user list, without requiring further entry by the administrator.

### SUMMARY

Described herein is system and method in which when a user logged into a client computer determines the existence of a server, the name of the user is automatically added to the list of users maintained by the server. With the user name automatically populated in the server user list, the administrator may easily select and configure access for the user.

In one embodiment, a method for automatically adding a user name to a user list includes receiving a login request including a user name at a client computer, discovering a server associated with the client computer, wherein the server includes a server user list saved on the server, and sending a request to add the user name to the server user list.

In another embodiment, a system for automatically adding a user name to a user list includes a client computer configured to receive a login request including a user name and a server including a user list, wherein the client computer discovers the server as being associated with the client computer and transmits a request to the server to add user name to the server user list.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram of for implementing a method of auto adding a user name to a server user list, according to an embodiment.

FIG. 2 is a block diagram illustrating an example client-server network that that may be used in connection with various embodiments described herein.

FIG. 3 is a block diagram illustrating an example computer system that may be used in connection with various embodiments described herein.

### DETAILED DESCRIPTION

After reading this description it will become apparent to one skilled in the art how to implement the invention in various alternative embodiments and alternative applications. However, although various embodiments will be described herein, it is understood that these embodiments are presented by way of example only, and not limitation. As such, this detailed description of various alternative embodiments should not be construed to limit the scope or breadth of the present invention as set forth in the appended claims.

The rise of networked storage server solutions in the market has been growing. This use of network infrastructure brings many challenges to the business world, such as handling security. As part of security, users are allotted user names and conditional access to server resources. Today, a system administrator manually creates user names in a list on the server and grants the users access to various selected resources. As explained above, this manual entry by the administrator is time consuming and requires an understanding of network server concepts. Consequently, a system and method which minimizes the administrator's time in creating server user lists is desired.

The present invention relates to a system and method for automatically populating a user name in a server user list. By automatically populating the user name in the server user list, the system administrator is relieved from manually entering user names and may focus his time elsewhere.

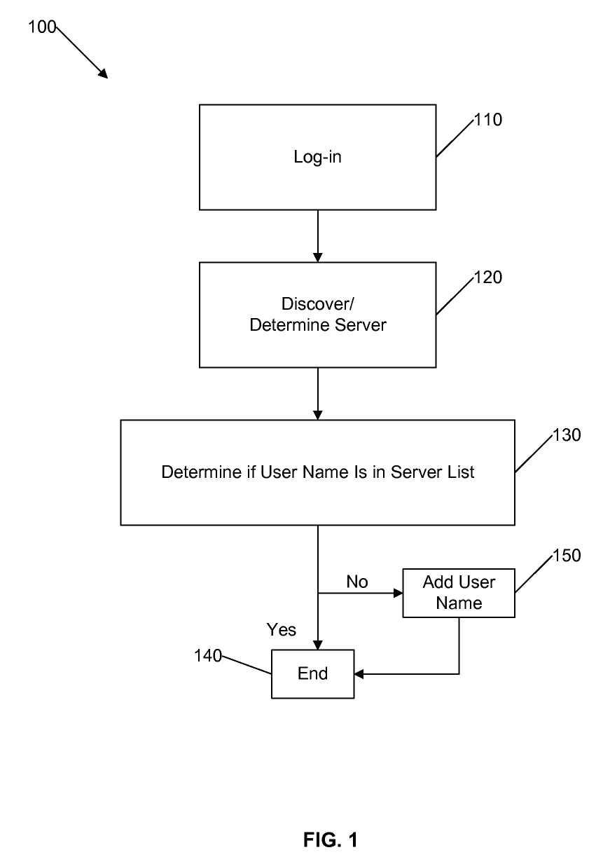

FIG. 1 is block diagram 100 for implementing a method of auto adding a user name to a server user list. In a first step 110, a user logs in to a client computer with his user name. The client computer is a computer that has access to a server on the server-client system via a network.

As is known in the art, in computing, users may need to identify themselves for the purposes of accounting, security, logging and resource management. In order to identify oneself, a user has an account (a user account) and a user name, and in most cases also a password. In a preferred embodiment, the user name has been assigned to the user from the client associated with the server-client system.

The client computer receives the login request from the user including the user name. In some embodiments, the client computer validates the login request for the received user name. Such validation may be performed by checking the user name and any associated passwords against a user login table, for example.

In step 120, the client computer uses a method to discover/determine the server over the network. In one embodiment, this method includes having the client computer broadcast a request to all devices on the network (e.g., via user datagram protocol (“UDP”)). When the server receives this request, the server responds by identifying itself to the client computer. In another embodiment, the method of discovering/determining the server includes utilizing universal plug and play (“uPnP”). In this method, the server sends out an uPnP signal when attached to a network and also responds to any uPnP requests for identification.

Once the client computer has determined the server over the network, the client computer then determines if the user name is known to the server at step 130. In one embodiment, the client computer determines if the user name is known to the server by scanning a list of known user names saved on a server user list. The server user list serves to provide a list of all available users known to the server and is available for the server administrator to use in configuring security and resource allocations.

The client computer may then determine if the user name is present in the server user list by performing matching or a Boolean-type comparison. Alternatively, the client computer may determine if the user name is present in the server user list using other searching tools known to those of skill in the art.

In some embodiments, once the client computer has determined that the user name is present in the server user list, the client computer then determines if the user name has permission to access the server. For example, in some embodiments, the user name may be saved in the server user list, but the user name may be marked as inactive or in such a way as to restrict access to previously granted permissions. In cases such as these, the user name is deemed not to be available.

If the user name is present in the server user list, the client computer ceases the search at step 140. If, however, the user name is new to the server, not present in the server user list, or deemed to be unavailable, the client computer sends a request to the server for the server to add the user name to the server user list at step 150. In the case where the user name is deemed to be unavailable, the request to add the user name to the user list results in the user name becoming available. Once the user name is added to the server user list by the server, the client computer ceases the search at step 140.

It should be appreciated that in some cases, the server may not already have a server user list saved. In some embodiments, when the client computer queries the server for the user name, the server may respond that a server user list does not exist. The server may then create a server user list by adding the user name to the user list.

Once the user name is present in the server user list, a system administrator may select and configure access for the user associated with the user name. For example, the administrator may configure conditional access to a user based on one or more pieces of information contained in the user account.

It is believed that by automatically adding user names to the server user list allows the administrator time to focus on other tasks. Additionally, eliminating manual entry of user names into the server list reduces errors saved in the server user list. For example, by automatically entering the user name from the client computer's request, it is almost certain that the user name will be entered correctly into the server user list. However, during manual entry, there is a fair likelihood that the administrator may incorrectly type the user name in to the server user list. Such typos may result in the correct user name not being allowed to utilize the client-server system, or worse, an unauthorized user name being allowed to utilize the client-server system.

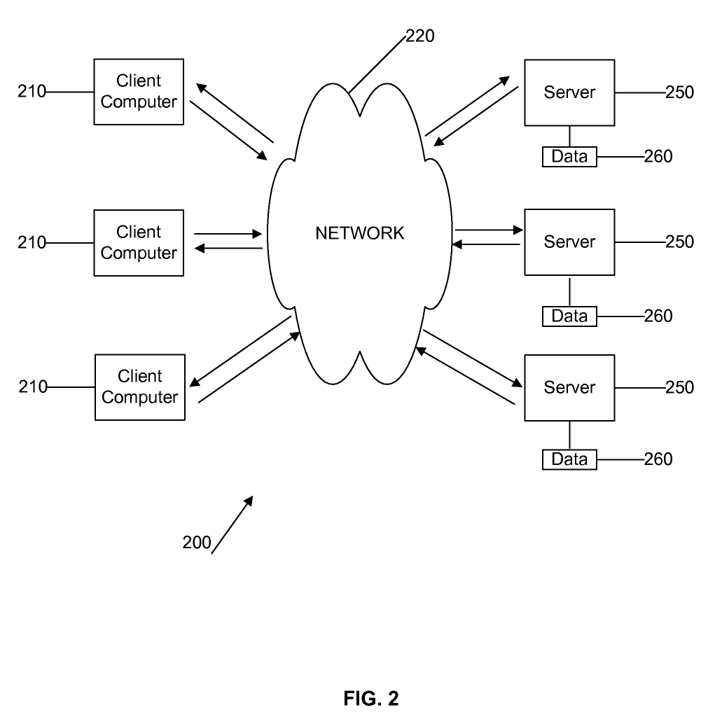

Turning now to FIG. 2, a block diagram illustrating an example client-server network 200 that that may be used in connection with various embodiments described herein is shown. For example, the client-server network 200 includes one or more client computers 210 in communication with a network 220.

Also in communication with network 220 is one or more servers 250 with data 260 stored thereon. In some embodiments, data 260 is not stored directly on server 250, but rather on external hardware (not shown) that server 250 is in communication with and has access to.

The client computers 210 and servers 250 are in communication with each other via network 220. Additionally, each client computer 210 may be in communication with other client computers 210 via network 220. Similarly, each server 250 may be in communication with the other servers 250 via network 220.

Network 220 may be a network such as the Internet and/or local area network. Network communication may be made through conventional wire connections, fiber optic connections, or through wireless methods, such as, for example, methods utilizing IEEE 802.11 (e.g., Wireless Fidelity), IEEE 802.15 (e.g., Bluetooth), and IrDA-based (Infrared Data Association) standards.

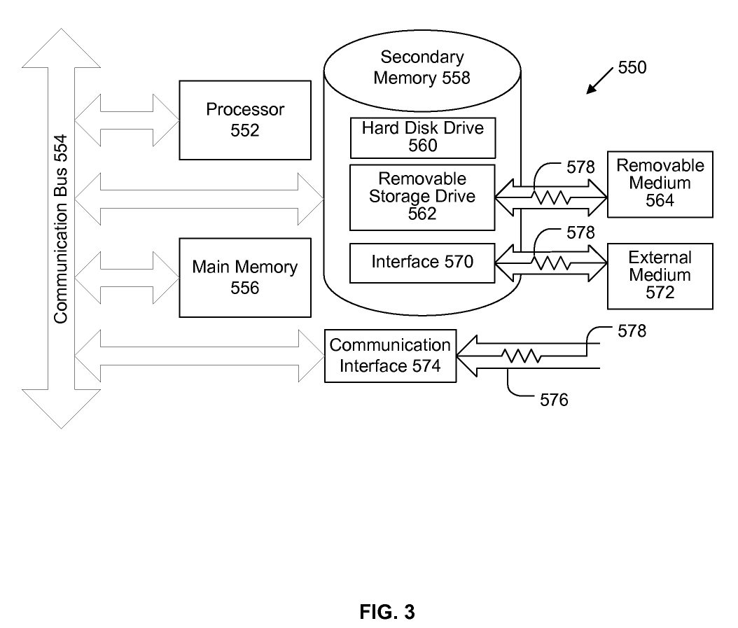

Turning now to FIG. 3, a block diagram illustrating an example computer system 550 that may be used in connection with various embodiments described herein is shown. For example, the computer system 550 may be used in conjunction with the method of auto adding a user name to a server user list, previously described with respect to FIG. 1. Other computer systems and/or architectures may also be used as will be understood by those skilled in the art. It should be appreciated that in a preferred embodiment, computer system 550 is representative of the client computer 210, as previously described with respect to FIG. 2.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A method for automatically adding a user name to a server user list comprising:
receiving a login request comprising a user name at a client computer;
discovering a server associated with the client computer, wherein the server includes a server user list saved on the server;
sending a request to add the user name to the server user list.

2. The method according to claim 1, further comprising validating the login request.

3. The method according to claim 2, wherein the validation of the login request is performed by checking the user name against a user login table.

4. The method according to claim 1, wherein the client computer and server are located on a network and wherein the server is discovered by the client computer broadcasting a request to all devices on the network and the server responds to the request by identifying itself to the client computer.

5. The method according to claim 1, wherein in response to the request to add the user name to the server user list, the server user list is searched to determine if the user name is already on the server user list.

6. The method according to claim 5, wherein the user name is not present on the server user list, the method further comprising automatically adding the user name to the server user list.

7. The method according to claim 5, wherein the user name is not available on the server user list, the method further comprising automatically adding the user name to the server user list.

8. The method according to claim 1, wherein the server user list serves to provide a list of all available users known to the server.

9. A system for automatically adding a user name to a server user list comprising:
a client computer configured to receive a login request comprising a user name; and
a server comprising a server user list;
wherein the client computer discovers the server as being associated with the client computer and transmits a request to the server to add the user name to the server user list.

10. The system according to claim 9, wherein the client computer is further configured to validate the login request.

11. The system according to claim 10, wherein the validation of the login request is performed by checking the user name against a user login table.

12. The system according to claim 9, wherein the client computer and server are located on a network and wherein the server is discovered by the client computer broadcasting a request to all devices on the network and the server responds to the request by identifying itself to the client computer.

13. The system according to claim 9, wherein the client computer and server are located on a network and wherein the server is discovered by the server sending out a universal plug and play signal identifying the server.

14. The system according to claim 9, wherein the client computer and server are located on a network and wherein the server is discovered by the client computer sending out a universal plug and play signal requesting the identification of all devices on the network and the server responds to the request with its identification.

15. The system according to claim 9, wherein in response to the request to add the user name to the server user list, the server user list is searched to determine if the user name is already on the server user list.

16. The system according to claim 15, wherein if the user name is not present on the server user list, the server automatically adds the user name to the server user list.

17. The system according to claim 15, wherein if the user name is not available on the server user list, the server automatically adds the user name to the server user list.

18. The system according to claim 9, wherein the server user list serves to provide a list of all available users known to the server.
